(19) United States
(12) Patent Application Publication
(10) Pub. No.: US 2003/0213371 A1
(43) Pub. Date: Nov. 20, 2003

(54) Conveyor-toaster control system

(76) Inventor: David N. Saunders, Saco, ME (US)

Correspondence Address: BOHAN, MATHERS & ASSOCIATES, LLC, PO BOX 17707, PORTLAND, ME, 04112-8707, US

(21) Appl. No.: 10/436,648

(22) Filed: May 13, 2003

Related U.S. Application Data
(60) Provisional application No. 60/380,563, filed on May 14, 2002.

(51) Int. Cl. A47J 37/08

(52) U.S. Cl. 99/327; 99/389

(57) ABSTRACT

A control system for a toaster oven incorporating a conveyor driven by an inexpensive ac motor, where the control system allows the entire range of toasting demands to be met while also compensating for variations in the line voltage. The heart of the toasting control is the reliance on the total dwell time of the bread products within the toasting zone of the oven, rather than on the speed of the motor. The control system also provides for a convection fan of varying speed without the need to replace the inexpensive muffin fan with more elaborate devices. Among the advantages offered by the dwell time approach is on-the-fly adjustment upward or downward of the degree of toasting, there being no need to await for the toasting zone to heat up or cool down to achieve this.

This application claims benefit under 35 USC §119(e) of the Provisional Application No. 60/380,563 filed May 14, 2002.

### BACKGROUND OF THE INVENTION

1. Field of the Invention

The present invention relates generally to toaster ovens and particularly to toaster ovens that transport bread products through a toasting chamber during the cooking process. More particularly, the invention relates to a microprocessor-based method and device for controlling such toaster ovens so as to adjust the degree of toasting, to adapt to different types of bread products, to compensate for line-voltage fluctuations, to enable power-conservation, and to effect other desired oven characteristics.

2. Description of the Prior Art

Conveyor toasters are popular convection ovens in which items of food stuff, usually bread-related, are transported on a motor-driven conveyor. Such ovens range from small counter-top bread/bagel/sandwich toasters to the large commercial ovens common at pizzerias. Typically, the conveyor's food-bearing surface moves along a substantially horizontal plane through a toasting chamber positioned between upper and lower heating elements. The toasting is effected by a combination of radiative and convective heat generated by upper and lower heating elements, either working in concert to provide uniform toasting on both sides of the (generally planar) food item, or alone, for those products that need be toasted on only one side. Because of the range of what people consider to be a proper degree of toasting, and because different types of bread products have different toasting susceptibilities, there must be some means available to the operator of the toaster for adjusting the “toasting energy” to which an item is exposed. The toasting energy (the quantify of heat) received by an item will be jointly dependent on the heat flux it exposed to (where heat flux will be dependent on the air temperature within the oven and the level of radiation from the heater, both determined by the heater temperature) and the length of time for which it is exposed. This being the case, one can vary the degree of toasting by changing the heater temperature, the conveyor speed, the rate at which the oven exchanges air with the outside, or a combination of all three. Only the heater temperature and the conveyor speed will be addressed here, though it is noted that the convection fan with which the typical toaster oven is equipped is far from a passive element in the operation.

Consider first changing the heater temperature while maintaining the conveyor speed constant. Presuming that the desired mode of operation is such that the throughput of toasted products is maintained at its maximum rate, this approach would require that the highest heater temperature be used for the products, such as bagels, that require the most toasting energy. For items, such as slices of white bread, requiring the lowest toasting energy, the lowest heater temperatures would be used. Typically the heating elements are energized by the mains electric power (the “line voltage”), either via a single-phase 117 Vac or 234 Vac line, by a 208 Vac three-phase-line, or, rarely, by a three-phase 480 Vac line. Since the typical heating element presents just a passive resistance (R) to the applied voltage (V), the current through the elements will be directly proportional to the applied voltage, and heating of the heating elements occurs through simple Joule heating, varying as the square of the heater-element current or, equivalently, as the square of the voltage (V) applied across the heater element. (The Joule power dissipated per cycle will be proportional to the mean square of that applied voltage.) For maximum temperature on the heater elements and hence in the toasting zone, the full line voltage would be placed across the heating element(s) all of the time. Reducing the mean voltage across the elements lowers their temperature. Although the electrical power dissipated by an element is directly proportional to the mean square of the voltage, the temperature response is more complicated, because of the manner in which heat is transferred from the elements into the toasting zone, by radiation, by convection, and by conduction. It is noted that once one is positioned to vary the heater-element temperature, by whatever means, one has the capacity to compensate for one of the banes of commercial toaster ovens: line voltage fluctuation and drift (drift being just a long-period fluctuation, “fluctuation” will generally be taken to refer to both short-term fluctuation and to drift).

Controlling the mean voltage across a heater element is commonly done by placing a phase controller in series with the line voltage to the heater element to be controlled. The phase controller is tantamount to a fast switch that is “on” for an adjustable fraction of each cycle of the line voltage and “off” for the rest of the time, so as to vary the mean square voltage across the heater element. The usual phase controller incorporates a triac and a circuit that will gate the triac at a determinable point in the line voltage cycle. The triac is the switchable component placed in series with the heater element; specifically, it is switched by voltage input to its gate electrode. In order to avoid a dc component to the voltage placed across the heater element output in this technique, equivalent portions of the negative- and positive-going halves of the cycle are applied to the element. With no gate input, the triac presents a blocking resistance to the ac voltage, but when a small dc voltage is applied to the gate, the triac freely passes the ac line voltage. Because of its high input impedance, the triac gate draws negligible power.

The triac is essentially a pair of SCRs wired in an antiparallel configuration and their gates tied together. That is, the “forward” direction of current for one of SCRs is in the opposite direction from the forward direction for the other. When a gate voltage is applied to switch them “on,” the line current will pass through one of them for the first half of the ac cycle and through the other for the other half. The nature of the SCR is that once turned “on” (so as to pass forward current) by a voltage pulse to the gate it will remain “on” as long as forward current is flowing. With a 60 Hz ac voltage, the forward voltage will fall to zero every 1/120th of a second. The zero-crossing point of the forward current will be delayed by an interval determined by the reactive component of the load. For a purely resistive load, such as is represented by a heater element, the line current phase is the same as the live voltage phase. Because of this, the phase controller switches the triac “on” during the second half of either the positive- or negative-going cycle, with a short voltage pulse to the gate. When the voltage falls through zero (the zero-crossing point), the triac switches off and current ceases. Then the gate is pulsed “on” again at the analogous position in the other half of the 60-Hz cycle. Adjusting the mean voltage in this manner involves setting the “delay angle” on the phase controller. As the delay angle is varied from zero to 180, the mean voltage applied to the heater element goes from full to zero.

This simple system of maintaining and/or adjusting the heater-element temperature provides a simple way of compensating for the inconstancy of the line voltage, the magnitude of which can typically varying over time by up to ±10% without being considered out of spec or as violating any performance standards. One means of compensating for this drift in phase-controller-based temperature regulation is to install within the oven an electronic temperature sensor coupled into an error-signal generator. The error signal is then fed into the phase controller so as to periodically adjust the delay angle so as to maintain a set temperature regardless of the variation in line voltage and other environmental conditions. The phase controller can thus be made into a very sensitive thermostat for the oven, without the need to resort to anything other than well-known circuit elements and sensors.

More typically, because of the lower cost, a relatively insensitive bimetallic-based temperature sensor is used to control an on-off switch in the line leading to the heater element, with the result that the voltage across the heater element cycles between full on and full off. That, combined with the bimetallic sensor's requirement of a relatively large temperature deviation from the set point for it to respond, leads to a relatively large oscillation in the oven temperature about that set point, much greater than the triac-based methods and other electronic approaches allow. Under the right circumstances, the performance advantage of the electronic approach and in particular the approach using the phase controller in combination with the electronic temperature sensor more than offsets the cost advantage of the bimetallic-switch control. For obvious reasons, the methods that rely on a feedback signal being generated by direct temperature measurement are referred to as “closed-loop” systems.

Regardless of the approach used, there are some serious disadvantages to controlling the toasting energy delivered to an item solely by varying the oven temperature. Most seriously it reduces the overall rate at which a distributed range of products can be toasted, since it requires the conveyor speed to be set so as to ensure that those items requiring the most toasting energy (e.g., bagels) are properly toasted with full power applied to the heater elements. This means that for the other food items, which will constitute the majority of the food types toasted in establishments not specializing in bagels, the heater power will have to be cut back so that they do not get burned during the long transit time through the toasting chamber. Obviously, the optimum production rate across all items will be attained by always maintaining the heating elements at their highest temperature and varying the time that the items spend in the toasting chamber (though this will not in general result in the lowest per-item cooking cost). Traditionally, this time control has been accomplished by varying the conveyor speed, the highest speed being used for the products that toast most readily and the lowest speeds for items like bagels.

Cost of manufacture is one of the paramount considerations going into the design of toaster ovens, especially those that will be used in large numbers in commercial establishments. This consideration underlies the decisions made about many of the oven components. For example, a typical toaster oven conveyor is driven by an inexpensive universal motor to which it is coupled through a gearbox and chain linkage. This setup permits the conveyor speed to be varied mechanically by changing the gear ratio, even as the simple motor continues to operate at a fixed speed. Of course, it is much more convenient to provide for electric or electronic control of the conveyor speed, an approach that is also more readily and flexibly automated than is the mechanical approach. The simplest method of controlling the conveyor speed electrically is to vary the voltage to the motor and hence the motor speed; this is the approach in many of the existing systems. Unfortunately, the inexpensive motors traditionally used with conveyor-based toasters do not function well at speeds that differ significantly from their synchronous speed. (For a line frequency of 60 Hz, the synchronous speed for a two-pole universal motor is 3600 RPM.)

For those systems that vary the ac motor speed in order to vary conveyor speed, the motor-voltage control is typically exercised through a variable resistance in series with the motor or by a phase controller (as discussed above) in series with the motor. Both the series resistance and the series phase controller approaches are relatively simple and low in cost, though the series resistance results in wasted Joule heating when the motor is being operated at any but the highest speeds. Both approaches falter when very low motor speeds are attempted, for the reason set out above. At motor speeds lower than the synchronous speed, the torque produced by the motor falls off, and at speeds significantly lower than the synchronous speed, the torque falls to the point where variable frictional forces in the motor's mechanical load become significant, and erratic operation of the motor (and the conveyor) can result. For example, the motor may stop completely even when a non-zero speed is desired and the corresponding non-zero voltage applied to the motor. Furthermore, as discussed elsewhere, the line voltage available in most facilities can fluctuate over a considerable range and still be considered “normal,” meaning that even if the motor is running at a speed high enough to ensure continuous operation, a drop in the line voltage may cause it to stall—and the toast to burn.

An alternative to the above approach is to use a dc motor in place of the universal ac motor. This gets away from the constraints on low-speed operation, though at a higher cost. Rosenbrock et al. (U.S. Pat. No. 5,197,375; issued Mar. 30, 1993, and U.S. Pat. No. 5,253,564; issued Oct. 19, 1993) discloses an advanced system incorporating a dc motor to drive the conveyor. Incorporating a microprocessor and various sensor/feedback loops, the Rosenbrock et al. system reportedly maintains the conveyor speed and the oven temperature at operator-selected levels, even as the line voltage varies irregularly. Conveyor speed is maintained in the system taught by Rosenbrock et al. through a control loop incorporating a motor-speed-monitoring sensor (optical-based or otherwise). This sensor generates an error signal whenever the conveyor speed begins to deviate from the speed selected, an error signal that causes an increase or decrease in voltage applied to the motor so as to counter an unwanted decrease or increase, respectively, in the conveyor speed. In this manner, all external influences, including line voltage fluctuation, tending to vary conveyor speed are compensated for. The voltage to the dc motor in the Rosenbrock et al. system comes from a power supply energized ultimately by the ac line voltage. The conveyor speed is controlled by toggling this power-supply-generated dc voltage to the motor on and off, so as to produce a train of similar voltage pulses at the motor input. Each pulse has a height corresponding to the full dc voltage and a width that is adjustable; the average voltage input to the motor is then varied by varying the pulse width in this Pulse Width Modulation (PWM) speed control. In Rosenbrock et al. the interval is never so long that the motor stops. For that matter, the circuitry in Rosenbrock et al. appears to be such that, because of induction and other mechanisms, the motor speed for a given PWM is essentially constant, not responding to the discreteness of the individual pulses. This method of maintaining conveyor speed through PWM and a speed-sensing feedback loop has the potential to provide very close control of the oven operation. However, it is very expensive compared to the traditional means of varying conveyor speed in toaster ovens. The cost is increased in part because of the additional feedback circuitry, including the sensor network, and the fact that dc motors of the type incorporated in the Rosenbrock et al. system are significantly more expensive than the universal motors traditionally-used in the industry. In general, the closed-loop toaster-oven systems of the prior art are capable of providing good temperature and conveyor speed control, but at a high monetary cost compared to the prior-art open-loop systems.

With the line voltage available at the toaster oven allowed to vary as much as ten percent about its nominal level, nominal 117 Vac single-phase line voltage can be as high as 129 Vac or as low as 105 Vac and still be acceptable under the rules governing the local utility responsible for delivering electricity. Since the heater elements are normally just wires or bars of resistance R, a simple expression gives the rate at which the elements give off (dissipate) energy, namely the Joule heating expression (V²/R). This means that the power dumped into the heating chamber increases by 21% when the line voltage increases by 10%. Although, as mentioned above, the temperature does not follow the power-dissipation level directly, a 21% increase in power dissipated increases the temperature in the oven significantly. The power radiated by the heaters varies with the fourth power of the heater temperature. Thus the temperature of the heating element has to increase only by 5% to increase radiative power by 22%.

Line voltage variations may be short lasting, but they may also endure for hours, reflecting demand elsewhere in the power network supplying the toaster-oven site. Thus, a large demand for air-conditioning may result in the line voltage at the toaster oven being reduced by as much as 10% for the entire afternoon. It is normally at the onset of the change in the line voltage that the most mischief is wrought with toaster ovens. A line-voltage reduction can result in untoasted bread emerging from the oven, and a line-voltage increase can result in carbonized toast and a smoke-filled eating establishment.

An important, though often slighted, component in the toaster oven is the convection fan used to circulate air within the oven. In a properly designed system, the convection fan increases the efficiency with which energy dissipated at the heater elements is delivered to the products being toasted. Historically, this function has been served by the simple, inexpensive muffin fan.

Traditionally, toaster-oven muffin fans have alternated between operating at full speed and not operating at all, as the voltage applied to them cycles between the full line voltage and zero voltage. Finer control over the fan speed would offer several advantages. For example, during inactive periods, when the heaters are placed on reduced-power standby mode, it would be useful to also reduce the fan speed to a lower, yet non-zero, level. Also it would be beneficial to maintain fan speed at its set level regardless of voltage fluctuation. Although there are ways that this can be achieved by the use of dc fans, it is again desirable for reasons of economy to achieve this control with the inexpensive ac muffin fans.

In addition to the quantitative improvements in toaster ovens that are described above, certain qualitative departures from traditional operation are also desirable. All of these improvements can be achieved by the use of microprocessors for toaster oven control. For example, one can set up the control unit at the beginning of each day or at the start of the season, or at the manufacturing plant, with criteria for placing the oven on stand-by operation. This may be as simple is having the shift to stand-by to occur at the same time or times each day, based on historical information regarding slow periods in the business. Alternatively, the shift to stand-by may be triggered whenever no toasting has taken place for a pre-selected time interval. The advantage of this approach is that it is automatic, with no need for a conscious decision on the part of the operator every time the shift to energy-conserving stand-by is made. Similarly, various start-up and shut-down modes may be built into the oven control and, with the flexibility provided by microprocessors, the toaster operator can easily set the various triggering criteria to meet the conditions at the specific establishment where the toaster is located, conditions that may vary throughout the year. As a yet-further improvement, the microprocessor-based control system could enable the operator to introduce a slight increase or slight decrease in the degree of toasting (the darkness) for a few items out of a large number that receive the “default” degree of toasting. The challenge is to introduce the numerous microprocessor-mediated improvements in a manner that avoids significant increases in the cost of manufacturing the toaster ovens.

Therefore, what is needed is a toaster-oven controller that permits easy operator-mediated control over the level of toasting energy supplied to the items to be toasted, while providing the capacity of maximizing the average throughout of a variety of items. What is further needed is such a controller that permits efficient control of the speed of the convection fans used with toaster ovens. What is yet further needed is a method of using such a controller so as to implement a wider range of start-up, shut-down, and stand-by protocols than have been used previously. What is still further needed is such a controller and method that can provide toasting processes impervious against short- or long-term line voltage variation. Moreover, what is needed is that the controller and method achieving these objectives do not add significantly to the cost of production of toaster ovens.

### SUMMARY OF THE INVENTION

An objective of the invention is to provide a control system for conveyor-based toaster ovens that guards such ovens and the products they produce against adverse effects from line-voltage fluctuations. Another objective is to provide such a control system that permits easy adjustment in the degree to which a given item in the oven is toasted, and that permits the accommodation of a large variety of food items with their concomitant range in toasting-energy requirements. It is a further objective that this control system provide the oven operator the ability to make these choices and also to make the choice between maximizing product throughput, on the one hand, and minimizing operating cost, on the other. Yet another objective is to introduce to such ovens' operation improved power-up, shut-down, and shift-to-standby protocols. An overriding objective is that all these objectives be achieved without significantly increasing the complexity nor the cost of the individual components of the control system.

The present invention meets the stated objectives by introducing particular microprocessor-based oven-control circuitry that does not incorporate the complexity of closed-loop systems. The invention also introduces a new philosophy regarding conveyor speed, one that emphasizes not conveyor speed per se but rather the dwell time within the toasting chamber of the items to be toasted. By such an emphasis, the present invention is able to avoid completely the problem of operating conveyor motors at very low speeds, a problem that the prior art has addressed by going to more expensive motors and/or to complex, expensive circuitry. Once it is realized—that for a toasting chamber presenting heating characteristics that are either uniform or slowly varying as a function of location, it can be seen that the exact nature of the transit of the bread items through the chamber is not important. In particular, since the degree of toasting is basically a function of the total toasting energy that the item receives, an item can move through in a stop/start fashion with no detriment to the final product, providing that the item's total dwell time is commensurate with its toasting-energy needs and the distribution of convective and radiative heating within the chamber. With this approach, there is clearly no upper limit to the dwell time in the cooking region, that is no lower limit to the average speed with which the conveyor moves. In an extreme example, the conveyor can mimic the toasting procedure of the simple home toaster, by moving the food item into the toasting chamber, halting the conveyor motor for the duration of time required for the item to be toasted, and then moving the item on out the exit. However, as a practical matter, the demands on the typical commercial conveyor toaster are such that a quasi-continuous transit of the food through the chamber is required. The word “microprocessor” is used throughout this discussion as a concise reference to any digital processing and control device or collection of devices, including without limitation those devices sometimes referred to as “microprocessors” or “microcontrollers.” Further, the term should be taken to encompass as well the support circuitry necessary for carrying out various peripheral functions including, but not necessarily limited to, analog-to-digital conversion, digital-to-analog conversion, timing, memory, digital input and output, watchdog, and reset or initialization. In summary, the use of the label “microprocessor” should not be taken as limiting in any way the range of embodiments of the invention described and claimed herein.

By permitting stop and start motion of the conveyor, one can retain the economic advantage provided by the inexpensive universal motors without having to be concerned with the erratic behavior of such motors under low-speed operation. In the present invention the motor receives either full line voltage or no voltage at all. Apart from the transient periods while the motor is getting up to speed and coasting to a stop, respectively, the motor (and conveyor) either operates at maximum speed or is at rest. The system controlling the motor must provide a duty cycle to the motor reflecting the dwell time required by whatever food item is then being toasted.

The on/off sequencing that the invention uses is based on the stable 60 Hz line frequency provided in the U.S. and most countries. Corresponding to this frequency is a period of one-sixtieth of a second (approximately 0.016 sec). In its Preferred Embodiment, the invention ensures the proper dwell time by alternating between applying the full ac voltage (or substantially the full voltage) for an integral number of such periods and completely removing the voltage from the motor for an integral number of periods. The motor sees bursts of ac line voltage. The shorter the bursts are (i.e., the fewer cycles for which the voltage is applied) the shorter distance the conveyor advances during each “on” interval. Similarly, as the time between bursts is made longer the conveyor is stopped for a longer time between bursts. The toasting operation depends on the conveyor's average speed while the item-to-be-toasted is within the toasting chamber, a joint function of the duration of the “on” intervals and the length of time between the “on” intervals. At one extreme, the controller applies the full ac line voltage to the motor without any interruption as the item travels through the oven. This defines the maximum conveyor speed for that line voltage, and the minimum dwell time (toasting time). In contrast, the controller may apply the voltage for a very small number of complete periods (say 5) and then wait for a large number of cycles (say 120) before applying the voltage again. In this case, the conveyor will move forward a small distance, say one-quarter inch, then pause for two seconds before moving another quarter-inch. It is easily understood that with this control scheme there is no lower limit to the average conveyor speed nor, consequently, no upper limit to the dwell time.

There are various ways in which the dwell-time approach of this invention can be implemented. This is particularly true for embodiments that devote one or more microprocessors to translating the independent parameter—total dwell time—to the on/off sequencing of the conveyor. Furthermore, with a microprocessor-based control unit, it is straightforward to increase or decrease the dwell time from its default value so as to comply with the customer's taste and also to adjust the dwell time so as to compensate for environmental factors, in particular line-voltage fluctuations. The latter function will require in one way or another a comparison of the line voltage magnitude with some fixed voltage reference. The invention depends on automatic electronic shifting of the on/off sequence to compensate immediately for a detected deviation of the line voltage. This might be a deviation up or down (usually down) from the nominal value or a shift from an erstwhile voltage level back to the nominal value for the line voltage. Alternatively, the measured change in line voltage can be compensated for by adjusting current through the heating elements so as to ensure that their temperature does not change, thus eliminating the need to adjust the dwell time in response to a change in the line voltage. Finally, some combination of dwell-time adjustment and heater current adjustment may be made to compensate for the change in line voltage. The present, microprocessor-based, invention provides the flexibility needed to select whichever combination is most beneficial, whether it is to minimize operating costs or to maximize production rates. If the establishment operating the oven is extremely busy, the emphasis will presumably always be maximizing output. Under those circumstances, for example, an increase in line voltage will be seized upon as an opportunity to cut down on dwell time. Of course, when the voltage dips, the only response can be to increase the dwell time, that is to decrease output.

Once a microprocessor has been introduced into the system, the other objectives of the present invention can be achieved by properly programming the microprocessor so as to provide the protocols for turning on the oven, for shutting down the oven, and for putting the oven on a pre-programmed stand-by mode. These protocols relate primarily to powering the heating elements, the fan motor, and the conveyor motor. For the purposes of controlling the fan, one can exercise the same type of start-and-stop operation as used with the conveyor motor, thus permitting the oven to use the traditional inexpensive muffin fan. In the alternative, if there is not a need to operate the fan at very low speeds, the traditional voltage-lowering can be used to vary fan speed. The most important aspect of the invention is the line-voltage-fluctuation compensation achieved by adjusting conveyor speed, heat settings, and/or fan speed. In practice the compensation is based on providing the microprocessor information gained by monitoring the line voltage or surrogate for the line voltage. Here the surrogate can be derived from the line voltage itself through any combination of discrete or integrated passive and active semiconductor devices (including without limitation, resistors, capacitors, inductors, diodes, transistors, and semiconductor controlled rectifiers). The surrogate itself can take the form of a voltage, current, frequency, phase angle, pulse width, pulse position, temperature, resistance, reactance, and so on, indeed any physical parameter detectable by the microprocessor. The choice made in the Preferred Embodiment is to generate for the surrogate a voltage derived directly from the line voltage by a step-down, isolating transformer. That approach also entails isolating the entire control circuit from the line voltage, the front end by a power transformer and the output end by optical-isolation devices. Alternatively, one could establish insulating barriers between the control circuit and the user, in which case there would be no need for isolation in the line-voltage surrogate generation path.

The commentary of the previous paragraph is provided so as to emphasize the many embodiments that a person skilled in the field and art can devise once the details of the present invention are known and the fact that the invention claimed is far broader than any particular detailed embodiment described in this document.

### BRIEF DESCRIPTION OF THE DRAWINGS

FIG. 1 is a block diagram of the invention's Preferred Embodiment, exclusive of the conveyor and the circuit that switches the conveyor motor on and off.

FIG. 2 is a diagram of the circuit used to turn the conveyor motor on and off in response to the on/off signals generated by the control unit logic in the Preferred Embodiment, as well as a block diagram of the conveyor motor and equipment linking the motor to the conveyor.

FIG. 3 depicts waveform representations illustrating various aspects and consequences of turning the conveyor motor voltage on and off.

FIG. 4 is a schematic depiction of the Preferred Embodiment keypad by which the operator selects the toaster operations desired and causes the system to deviate from any default values built into it.

### DETAILED DESCRIPTION OF THE PREFERRED EMBODIMENT

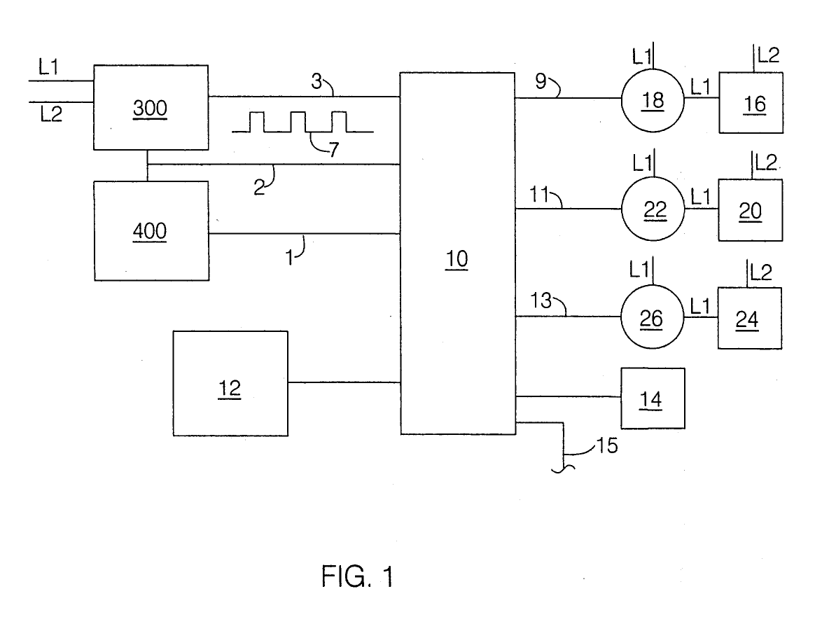

The following discussion is best followed with reference to FIG. 1, which is a block diagram of a number of the invention's components that are configured by long-known techniques and circuits. The invention is designed to use standard ac line voltage such as is available in most homes and business establishments. The Preferred Embodiment is configured in particular to be energized by single-phase ac power such as is available in the United States and Canada (referred to alternately as ac line voltage, ac line power, or simply line voltage). In the Preferred Embodiment, the line voltage is introduced over a first ac line L1 and a second ac line L2 to several input points in the system. These input points are isolated from one another, and the line voltage is isolated from ground. In particular, and most importantly, the line voltage is isolated from the low-voltage dc voltages produced within the system as control signals.

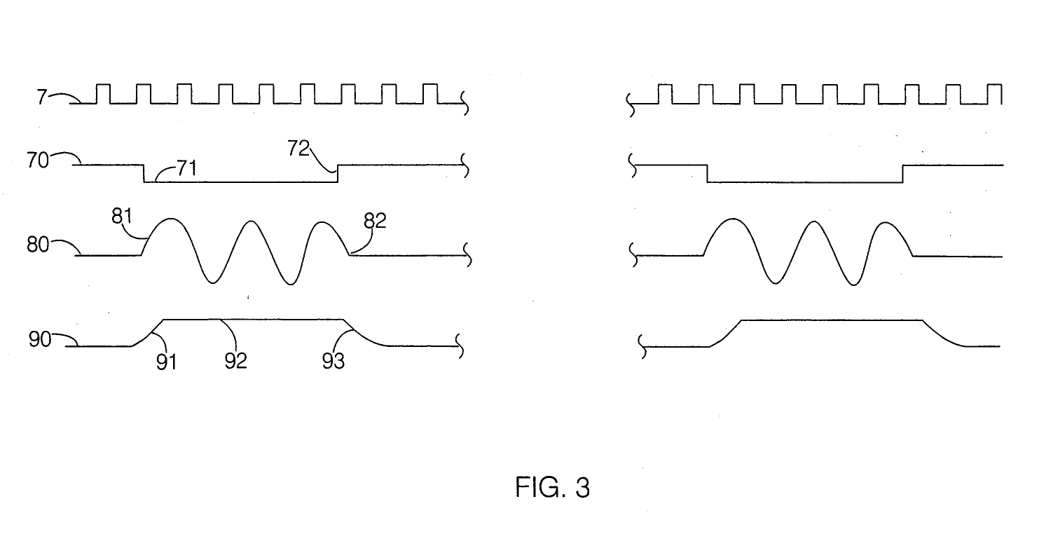

As can be seen from FIG. 1, the line voltage is introduced to a converter 300. The converter 300 is a standard ac-to-dc converter that includes a step-down transformer so that it converts the nominal line voltage of 117 Vac to an unregulated dc voltage with a nominal voltage of 8 Vdc which is output on unregulated-dc line 2. In addition to stepping down the ac voltage, the step-down transformer portion of the converter 300 isolates the line voltage from the stepped-down ac and hence from the unregulated dc voltage appearing on unregulated-dc line 2. Also produced by the converter 300 is a zero-crossing pulse train 7 consisting of a 120-Hz train of positive-going pulses each pulse synchronized to the instant that the ac line voltage passes through zero (120 times a second for the 60-Hz signal) in such a way that half of each pulse precedes the zero-crossing and half follows it. The individual pulses have a fixed width of approximately 1 ms, a height on the order of one volt, and are output over a zero-crossing line 3. (See FIG. 1 and FIG. 3.) It is the zero-crossing pulse train 7 that provides the synchronizing and counting means for the control system. Both the rising and the falling pulse edges are used, the rising edge serving to “wake up” the controller and the falling edge to cause the motor's turn-on signal to be issued. This permits a well-defined turn-on time, and hence minimizes jitter in the triggering point location from one turn-on phase to the next.

The unregulated-dc line 2 is connected to a digital control unit 10 and to a dc regulator 400. The dc regulator 400 converts the unregulated voltage from the unregulated-dc line 2 to a regulated (constant) 5 Vdc output on regulated-dc line 1 that is coupled directly to the control unit 10, to which it provides operating power. The digital control unit 10 is in major part a microprocessor. Note that in addition to the regulated-dc line 1 and the unregulated-dc line 2, the control unit 10 has as an input the zero-crossing line 3; the zero-crossing pulse train 7 plays a clock and synchronizer role for the control unit 10.

As further depicted schematically in FIG. 1, a keypad 12 is coupled to the control unit 10. The keypad 12 is the means by which the oven operator interacts with the control unit 10 either to enter specific operational commands or to vary certain pre-programmed tasks. As will be discussed further below, there are buttons corresponding to the most common food types expected to be placed in the oven for toasting. In addition, there is a button to depress to slightly increase the dwell time, whatever the pre-programmed protocol calls for, and another to decrease the dwell time slightly. The keypad 12 and its configuration with the control unit 10 also provides the operator more advanced control options such as the capacity to change default settings for the power-up and shut-down procedures, respectively. Further, in the Preferred Embodiment, the keypad 12 allows the operator to select 30 min, 60 min, or 90 min as the time interval that must pass with no operator input before the oven enters stand-by. For monitoring the operation and changes in the oven, the system is equipped with a visual display 14 coupled to the control unit 10. Visual information presented by the display 14 includes such things as (a) the time remaining (during power-up or start-up from standby) until the oven reaches operating temperature, (b) the time remaining before the oven goes into standby mode absent an input, (c) time remaining in standby mode before complete shut-down occurs absent input, and other time information useful to the operator in planning his/her production.

Additional control signals generated by the control unit 10 include a top-heater-control signal, which is output on a top-heater-control line 9, a bottom-heater-control-signal which is output on bottom-heater-control line 11, a fan-control signal, which is output on a fan-control-signal line 13, and a conveyor-control signal, which is output on a conveyor-motor control signal line 15. All of these control signals are binary in nature, with a HI-to-LO difference being on the order of a few volts. These control signals all look into high-impedance inputs, details of which are set out below.

As can be seen with further reference to the block diagram of FIG. 1, the Preferred Embodiment includes a top-heater control circuit 18, which is basically a switch interposed between the first ac line L1 and a first end of a top-heater element 16, a second end of the top-heater element 16 being connected directly to the second ac line L2. In the Preferred Embodiment, the top-heater control circuit 18 incorporates a phase controller (not shown) such was described earlier. The control unit 10 determines the delay angle of the phase controller and hence the fraction of each cycle for which full power is to be applied to the top-heater element 16. The top-heater element 16 being a simple resistance, with no reactive component, the power that top-heater element 16 dissipates is directly proportional to the mean square voltage applied to it, the mean square voltage value being determined by the delay angle. The full ac line voltage is turned on by a brief logic HI signal, but turns off by itself when next the current through the phase controller passes through zero. Because the top-heater element 16 constitutes a non-reactive load for the top-heater control circuit 18, the current through it will pass through zero at essentially the same instant that the voltage applied to the it passes through zero.

A similar arrangement determines the average power dissipated in a bottom-heater element 20, which is also a simple resistive element. The bottom-heater-control line 11 provides control input to a bottom-heater control circuit 22 which is interposed between first ac line L1 and a bottom heater element 20. The current through the bottom heater element 20 is controlled in the same manner as described above for the top-heater element 16.

The fan-control line 13 is connected to a fan control circuit 26 which in turn is coupled to a muffin fan 24. The speed of the muffin fan 24 is controlled by the fraction of the line voltage cycle that is applied to it. This fraction in turn is controlled in the same manner as described above in the description of the control of the current through the top-heater element 16 and the bottom-heater element 20.

The monitoring of the unregulated-dc signal by the control unit 10 is the key to the steps taken by the control unit 10 in compensating for variations in the line voltage amplitude. In other words, the signal on unregulated-dc line 2 is a fluctuation surrogate for the ac line voltage. The unregulated-dc signal will have an amplitude (magnitude) that is directly proportional to the ac line voltage amplitude. For example, a variation in the ac line voltage amplitude by ±10% about its nominal peak-to-peak amplitude of 117 volts will result in the unregulated-dc voltage on unregulated-dc line 2 also varying by ±10%, with a resulting range of 7.2 to 8.8 Vdc.

In order to use the varying amplitude of the voltage on the unregulated-dc line 2 directly to determine line voltage drift, it is necessary to recognize and take account of variations in the unregulated-dc voltage that arise from sources unrelated to the ac line voltage variation. The most significant such source in the Preferred Embodiment is the change in the unregulated-dc voltage that occurs because of changing current demands put on it by the regulator 400. The regulator 400 has as its sole function the maintenance of a constant 5 Vdc output on regulated-dc line 1 in the face of the current demands put on the regulated-dc line 1 by the load it powers. As the regulator 400 meets this function, its demand for current from the unregulated-dc voltage line 2 varies causing the voltage on the unregulated-dc voltage line 2 to vary also, as a function of the output impedance of the converter 300. The visual display 14 is the major cause of the variation in current demand placed on the regulated-dc line 1, primarily because of the varying information the visual display 14 is called on to present. (All the other outputs of the control unit 10 go to high impedance connections.) The Preferred Embodiment deals with this effect by ensuring that the measurement of the variation of voltage on the unregulated-dc line 2 is always done with the same load on regulated-dc line 1, by returning the visual display 14 to a specific reference mode for the fraction of a second that the variation is measured. That is, the interval for which the circuit must be held at the reference mode is very short, only long enough for the voltage on unregulated-dc line 2 to arrive to a level reflective of the ac line voltage, a small fraction of a second, and hence not enough to interfere with the operator's visual observation of the visual display 14.

As stated above, the “clock” for the control unit 10 is provided by the signal on the zero-crossing line 3, the zero-crossing pulse train 7 on that line providing 120 Hz “ticks” of the clock, with the individual pulses synchronized to the zero-crossing times of the ac voltage input to the power supply. Everything that is done by the system is done for an even number of such ticks.

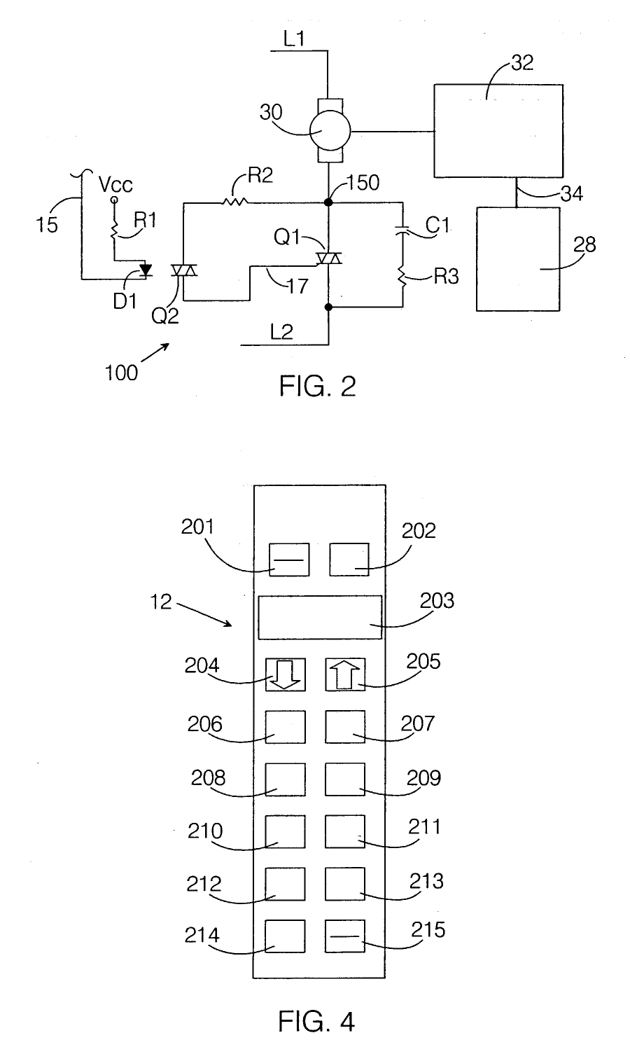

The key control signal from the control unit 10 is a motor-control signal 70 output on motor-control-signal line 15. The motor-control signal 70 reflect all the information that the control unit 10 has been given or has calculated regarding the demand for the quantity of energy that the bread items are to be exposed to. This motor-control-signal line 15 can be seen in FIG. 1, where it is shown as an output from the control unit 10, and also in FIG. 2, where it is shown as the input to a motor control circuit 100.

As depicted schematically in FIG. 2, a conveyor 28 is driven by a conveyor motor 30 coupled to the conveyor 28 through a gearbox 32 and a chain drive 34. The motor 30 is powered by the ac line voltage, the first ac line L1 being connected directly to the motor 30 and the second ac line L2 being connected to the motor 30 through the motor control circuit 100.

The control unit 10 monitors the zero-crossing pulse train 7 with pulses synchronized to the zero crossings is shown in FIG. 1. A zero-crossing pulse will appear every 8.33 ms for a 60 Hz line voltage. The zero-crossing pulses identify the cycles of the ac line so that the control unit 10 can produce the pulse that switches the motor 30 on or off to within a precision of 1/120 of a second. That is, the control unit 10 counts pulses on the zero-crossing pulse train 7 and, when the total equals a number predetermined based the desired dwell time, it outputs an appropriate signal on the motor-control-signal line 15 to the motor control circuit 100 so as to interrupt the ac line voltage to the motor 30. Then the pulse count by the control unit 10 begins again and when the total reaches a predetermined number, the control unit 10, again acting on the control circuit 100, allows the full ac line voltage to be applied once again to the motor 30. This pattern continues to repeat until the operator changes the dwell time through inputting new information to the control unit 10 through the keypad 12. The details about the way in which the motor control circuit 100 operates are given in the next paragraphs.

As with the other control signals in the Preferred Embodiment, the motor-control signal 70 is binary in nature. When the motor-control signal 70 is HI, it causes the control circuit 100 to interrupt completely the ac line voltage to the motor 30. This is the low-voltage regime. When it is LO, it causes the control circuit 100 to permit the full ac line voltage, the high-voltage regime. FIG. 3 illustrates this sequence. The top line in FIG. 3 represents the zero-crossing pulse train 7; the second line is the motor-control signal 70 output by the control unit 10 on motor-control line 15; the line below that depicts a motor input voltage 80; and the bottom line roughly depicts a motor speed 90. The four lines are synchronized and indicate the following. The motor-control signal 70 is initially HI, resulting in the motor input voltage 80 being zero, holding the motor speed 90 to zero. Coincident with the second pulse in the zero-crossing pulse train 7, the control unit 10 causes the motor-control signal 70 to switch from HI to LO at a turn-on point 71. As a consequence the control circuit 100 causes the full ac line voltage to be applied to the motor 30, as depicted by the motor input voltage 80 trace between a voltage start 81 and a voltage stop 82, all as set out in FIG. 3. With continuing reference to FIG. 3, it can be seen that coinciding with the voltage start 81, the motor speed 90 becomes non-zero and, after going through a speed-up phase 91, the motor speed 90 reaches full speed 92. Similarly, when, after four zero-crossing pulses, the motor-control signal 70 switches back from LO to HI at a turn-off point 72, all input voltage is removed from the motor at a voltage stop point 82, and the motor 30 coasts to a stop during a coast-down phase 93.

FIG. 2 depicts the control circuit 100, for the purpose of illustrating the means by which commands from the control unit 10 cause the motor input voltage 80 to the motor 30 to be switched between zero and the full ac line voltage, that is, for the line voltage to the motor 30 to be switched on and off. The motor-control signal 70 from the control unit 10, carried on conveyor-motor-control signal line 15, effects these changes in a series of steps designed to isolate the ac line voltage from the control unit 10 and its associated circuits. The conveyor-motor-control signal line 15 is connected directly to the negative side of a light-emitting diode D1, as can be seen in FIG. 2. The positive side of the diode D1 is biased to +5 Vdc by regulated-dc voltage line 1 (connection not shown) through a first current-limiting resistor R1, 330 ohms in the Preferred Embodiment. When the motor-control signal 70 is switched from HI to LO, current flows through diode D1, causing it to emit light which, in turn, activates (turns on) a light-activated switch Q2 (a triac) so that light-activated switch Q2 becomes freely conducting in both directions. Once light-activated switch Q2 is fully conducting, the full ac line voltage appears at node 150, causing a coupling triac Q1 to turn on, so as to complete the circuit between first ac line L1 and second ac line L2 through the motor 30. The full ac line voltage continues to be applied to the motor 30 as long as diode D1 is emitting light, that is as long as conveyor-motor-control signal line 15 is held at LO.

The control circuit 100 also includes a snubber circuit consisting of snubber capacitor C1, 0.05 pF in this embodiment, and snubber resistor R3, 100 ohms in this embodiment, shunting the coupling triac Q1. The function of this snubber circuit is to reduce or eliminate oscillations in the control circuit that otherwise would tend to occur at the turn-on and turn-off times.

In the Preferred Embodiment, the light-emitting diode D1 and the light-activated switch Q2 are included in a standard off-the-shelve device of the type used to provide optical coupling (and electrical isolation) between two electrical circuits. The part number of this unit is TLP 160J, manufactured by TOSHIBA.

The control unit 10 is configured by well-known techniques to incorporate the algorithms needed to effect the various toasting protocols called for by the particular toaster specifications. In the Preferred Embodiment, it is configured to allow the operator to vary the duty cycle from essentially 100% (conveyor running continuously at full speed), down to 5% (resulting in products spending 20 times as long in the cooking zone as they do at 100% duty cycle). Also in the Preferred Embodiment, the operator is able to set up a shift-to-stand-by protocol whereby if the toaster has not had any inputs from the operator for some multiple of 30 minutes, it goes into standby mode, causing the heaters to be cut back to half power and causing the fan speed to be cut back as well. If a further predetermined period (typically 30 minutes) passes after it enters standby mode, the toaster is shut off completely.

FIG. 4 shows the keypad 12 in the Preferred Embodiment. It includes an “on” button 201 and an “off” button 202. Also on the keypad 12 is a status display 203, which indicates various key time intervals, such as time-to-standby, time-to-shutdown, and time-to-full-turn-on (during power-up), and also provides the operator information about the current status of the toaster, such as the type of bread item it is set to toast. Below the status display 203 is a step-down button 204 for making the toast one-half step darker, on the fly. Depressing it causes a slight reduction in the duty cycle of the motor. Similarly, a step-up button 205 enables the operator to make the toast in process one-step lighter. In the Preferred Embodiment, the step-down button 204 is labeled “DARKER” and the step-up button 205 “LIGHTER. The oven is pre-programmed for several common types of bread products, permitting the operator to simply press the button corresponding to each of those types in order to obtain the-proper toasting parameters. Thus, there is a toast button 206, a bagel button 207 (which will cause a long dwell time while limiting heat to just the top-heater), and a muffin button 208 (calling for a heater/dwell time combination appropriate for most English muffins). Also there is a particular-pre-programmed-protocol button 209 for calling up a particular protocol that has been programmed by the operator or, during original set-up, by the manufacturer. Closely related to this function is the control provided by a protocol-choice button 214, which enables the operator to make a menu-based choice from a number of pre-programmed protocols, the difference being that the protocols accessible through the protocol-choice button 214 are more difficult to modify than is that accessible through the pre-programmed-protocol button 209.

The keypad 12 also allows the operator to easily introduce variants to the pre-programmed protocols. Perhaps the most used of these variants will be the LIGHTER and DARKER commands. For example, with the bagel button 207 depressed, and the legend BAGEL displayed on the status display 203, the operator may push the step-down button 204 (DARKER) once. This has two effects. One is to extend the toasting time by approximately 10% and to cause the display on the status display 203 to begin to alternate between BAGEL and DARK. After a time interval sufficient for the operator to load the untoasted bagel and for the item to pass through the toasting chamber, the control reverts automatically to the default dwell time for bagels. If the operator pushes the step-down button 204 twice, the dwell time is extended for approximately 20% and while the piece is toasting the display on the status display 203 alternates between BAGEL and XDARK—until the appropriate time interval has elapsed, and the controls go back to the bagel default dwell time and the display goes by to a continuous BAGEL. A similar variant is available for making the item one or two stages lighter than the default dwell time for the species of bread item would result in. Although in the Preferred Embodiment, each step lighter or darker results in a change of about 10% in the dwell time, this increment can be modified by the supervisor to be any desired step. As a safeguard, the apparatus can only be re-programmed through password-protected access, presumably limited to managers and the like.

Also, through a top-heat button 210 and a bottom-heat button 212, the operator can choose to have one or the other of the heaters (or both or neither!) operating. Through a power-saver button 211, the operator can determine whether the standby-mode option is activated. A manual dwell-time-adjust button 213 permits a manual adjustment of the dwell time over a continuous range (in contrast with the single discrete change in dwell time available through either the step-up button 205 or the step-down button 206), by adjusting the motor duty cycle over a continuous range.

The details of one particular embodiment, the Preferred Embodiment, have been set out above. In so doing, there is no intention of limiting the invention claimed to this Preferred Embodiment. The full scope of the invention is defined in the Summary; those skilled in the art can readily develop alternatives to the Preferred Embodiment while staying within the invention's scope.

Having described my invention, I claim:

1. A method for toasting a food item to a degree of toasting selected by an operator using a toaster oven powered from ac line voltage and equipped with
a toasting zone, and
a conveyor for conveying said food item through said toasting zone, said method comprising the steps of
(a) placing said food item on said conveyor for conveyance through said toasting zone, and
(b) causing said conveyor to convey said food item so that said conveyor has a conveyor speed that varies in such a manner that said food item remains in said toasting zone for a total dwell time that results in said food item receiving a total toasting energy necessary and sufficient for said food item to reach said degree of toasting.

2. The method of claim 1 wherein also including a mechanism for compensating for variations in said line voltage, so that said toasting energy does not vary as a result of said variations.

3. The method of claim 2 wherein said mechanism for compensating involves varying an energy flux within said toasting zone.

4. The method of claim 2 wherein said mechanism for compensating involves compensatingly varying said dwell time.

5. The method set out in claim 2 wherein said mechanism for compensating involves a combination of varying said dwell time and varying said energy flux.

6. The method set out in claim 5 wherein said conveyor is driven by a simple ac motor linked to said conveyor, wherein said motor is powered by an ac voltage input and has a motor speed that depends upon said input voltage, and wherein said conveyor speed is varied between a first conveyor speed and a second conveyor, said first conveyor speed being established by setting said voltage input to a high voltage and said second conveyor speed being established by setting said voltage input to a low voltage.

7. The method set out in claim 6 wherein said high voltage equals full ac line voltage and said low voltage is zero, a transition from said high voltage to said low voltage being denoted a high-to-low transition, and a transition from said low voltage to said high voltage being denoted a low-to-high transition.

8. The method set out in claim 7 with the added step of causing both said high-to-low transition and said low-to-high transition to occur in synchrony with a phase of said line voltage.

9. The method set out in claim 8 wherein said high-to-low transition is made to occur at or near a zero-crossing phase of said line voltage.

10. The method set out in claim 9 wherein said mechanism for compensating for variations in said line voltage is based on monitoring a line-voltage-surrogate voltage, and causing said dwell time to increase when said surrogate voltage decreases and causing said dwell time to decrease when said surrogate voltage increases.

11. A control device for toasting a variety of food items to a range of operator-selected toasting degrees using a toaster oven equipped with
a toasting zone containing an energy flux,
a circulating fan,
a conveyor for conveying a food item through said toasting zone,
an ac conveyor motor driven by ac line voltage having a nominal voltage level, wherein said motor is linked to and drives said conveyor, and said motor operates at a motor speed dependent on said voltage input,
said device comprising:
circuitry for varying said motor speed between a discrete high speed and a discrete low speed while said food item is within said toasting zone so as to establish a particular dwell time for said food item within said toasting zone, said dwell time being selected to achieve a particular one of said operator-selected toasting degrees.

12. The control device described in claim 11 wherein said circuitry also monitors said line voltage and in response to deviations of said line voltage from said nominal voltage level makes compensating adjustments in said dwell time.

13. The control device described in claim 11 wherein said circuity also monitors said line voltage and in response to deviations of said line voltage from said nominal voltage level makes compensating adjustments in said energy flux.

14. The control device described in claim 11 wherein said circuitry also monitors said line voltage and in response to deviations of said line voltage from said nominal voltage level makes compensating adjustments so that said particular one of said operator-selected toasting degrees is not affected by said deviations, wherein said compensating adjustments include a combination of varying said dwell time and varying said energy flux.

15. The control device described in claim 14 wherein said circuitry includes
a microprocessor, an operator-controlled input circuit, and an ac-line-voltage switch,
wherein said input circuit is connected directly to said microprocessor, said input circuit including activator elements corresponding to different food item types and to different toasting degree choices and wherein said input circuit inputs to said microprocessor a command signal appropriate to any combination of said activator elements selected by an operator, and wherein said microprocessor generates a motor-control binary sequence correlated to said command signal, said motor-control binary sequence being then input to a motor control circuit, wherein said motor control circuit is a switch interposed between said motor and said ac line and said switch is turned on or off by an instantaneous logic level of said motor-control binary sequence and wherein said motor-control binary sequence thereby causes said motor to alternate between being powered by a high ac voltage and a low ac voltage in such manner that said high speed and said low speed are alternately selected, resulting in said dwell time being appropriate to said command signal.

16. The control device claimed in claim 15 wherein said high ac voltage is equal to full line voltage and said low ac voltage is equal to zero.

17. The control device claimed in claim 16 wherein said microprocessor also controls a fan speed of said circulating fan, modifying said fan speed in response to changing operating states of said toaster oven so as to conserve electric power.

18. The control device claimed in claim 15 wherein said binary sequence is input to said motor control circuit through an isolation means that electrically isolates said microprocessor from said motor control circuit.

19. The control device claimed in claim 18 wherein said isolation means relies on said binary sequence being conveyed between said microprocessor and said motor control circuit by light emitted from a light-emitting diode and received by a light-activated triac.

20. The control device claimed in claim 15 wherein said input device is a keyboard, said activating elements are buttons, said buttons corresponding to choices selected from a group that includes toasting degree step-down, toasting degree step-up, top-heat adjust, bottom-heat adjust, muffin toasting, bread-slice toasting, bagel toasting, power-saving mode adjust, manual conveyor-speed-adjusting, preprogrammed protocol select, power-on, power-off, and stand-by.

21. The control device claimed in claim 20 wherein said keypad also includes a status display to indicate an interval until toaster will power down or change to standby mode and wherein said status display also characterizes a toasting operation in process at any given time.

22. The control device claimed in claim 21 wherein said keypad includes a step-down button and a step-up button and said microprocessor is configured so that depressing said step-down button will increase said dwell-time by a preprogrammed fractional increment and will cause said status display to indicate that said dwell-time has been thus increased and further so that depressing said step-up button will cause said dwell-time to decrease by a pre-programmed decrement and will cause said status display to indicate that said dwell-time has been thus decreased.

23. Microprocessor-based control apparatus for operating a toaster oven containing a toasting zone, a conveyor for transporting bread products through said toasting zone, a universal ac motor for driving said conveyor, a muffin fan for circulating air through said toasting zone, a top heater element for delivering radiative and convective energy to said bread products, a lower heating element for delivering radiative and convective energy to said bread products, said control apparatus comprising:
(a) a converter that includes a step-down transformer adapted to receive ac line voltage as input a rectifier circuit adapted to received input from said step-down transformer, and a zero-crossing pulse-train generator,
(b) a regulator adapted to receive an unregulated dc voltage signal from said rectifier circuit and to produce a regulated dc voltage signal,
(c) a power cord capable of coupling said ac line voltage to said converter,
(d) a microprocessor including a microprocessor power input wherein said regulated dc voltage signal is connected directly to said microprocessor and energizes said microprocessor,
(e) a keypad for entering operator commands to said microprocessor and a microprocessor command input in said microprocessor that is connected to said keypad for receiving said operator commands, and a
(f) a motor control circuit,
wherein said microprocessor is programmed produce to a motor control signal
wherein said motor control signal is output to said motor control circuit, wherein said zero-crossing pulse-train generator produces a series of millisecond-width pulses having a frequency of 120 Hz, wherein each of said pulses corresponds to an instant when said ac line voltage passes through zero, with half of said each of said pulses preceding said instant and half follows said instant, and wherein microprocessor includes a pulse-train input to which said series of millisecond pulses is coupled and serves as a clock for said microprocessor wherein said microprocessor complies with said operator command by causing said motor control circuit to alternately set a conveyor motor input voltage to full ac line voltage or to zero, thereby determining an average speed for said conveyor and hence a dwell time within said toasting zone for each bread item located said conveyor.

24. An open-loop control device for use with a toaster oven having
(a) a toasting zone containing an energy flux and
(b) a conveyor for conveying a food item through said toasting zone, as said food item is toasted to a final degree of toasting, said toaster oven being powered by ac line voltage, said device comprising a microprocessor-based circuit configured so as to be able to vary said energy flux in response to a change in said line voltage, wherein said microprocessor is programmed to vary said energy flux in a manner that ensures that said change in said line voltage does not affect said final degree of toasting.

25. Control apparatus for operating a toaster oven containing a toasting zone, a conveyor for transporting bread products through said toasting zone, and heater elements for delivering energy to said bread products as a function of heater-element temperature, said control apparatus comprising a microprocessor and a plurality of toasting control input devices capable of providing input signals to said microprocessor, said microprocessor being coupled to said heater elements and configured so as to be able to vary said heater-element temperature in response to operator-activation of one or more of said input devices so as to cause said bread products to arrive at a desired final degree of toasting.

26. The control apparatus as described in claim 25 wherein one of said plurality of input devices is a step-up button, wherein said step-up button, when activated, causes said microprocessor to increase said heater temperature by a small increment, said small increment resulting in said final degree of toasting being increased by a small degree.

27. The control apparatus as described in claim 25 wherein one of said plurality of input devices is a step-down button, said step-down button, when activated, causes said microprocessor to decrease said heater temperature by a small increment, said small increment resulting in said final degree of toasting being decreased by a small degree.

28. The control apparatus as described in claim 26 wherein said step-up button, once activated, remains activated for a period of time and then self-deactivates, said period of time being sufficient for one of said bread products to traverse said toasting zone.

29. The control apparatus as described in claim 27 wherein said step-down button, once activated, remains activated for a period of time and then self-deactivates, said period of time being sufficient for one of said bread products to traverse said toasting zone.

30. Control apparatus for operating a toaster oven containing a toasting zone, a conveyor for transporting bread products through said toasting zone and a conveyor motor for driving said conveyor, and heater elements for delivering energy to said bread products as a function of heater-element temperature, said control apparatus comprising a microprocessor and a plurality of toasting control input devices capable of providing input signals to said microprocessor, said microprocessor being coupled to said conveyor motor and configured so as to be able to establish a speed for said conveyor motor in response to operator-activation of one or more of said input devices so as to cause said bread products to establish a dwell time within said toasting zone wherein said dwell time is chosen to produce a desired final degree of toasting of said bread products.

31. The control apparatus as described in claim 30 wherein one of said plurality of input devices is a step-up button, wherein said step-up button, when activated, causes said microprocessor to increase said dwell time by a small dwell-time increment, said small dwell-time increment causing said final degree of toasting to be increased by a small degree.

32. The control apparatus as described in claim 31 wherein said step-up button, once activated, remains activated for a period of time and then self-deactivates, said period of time being sufficient for one of said bread products to traverse said toasting zone.

33. The control apparatus as described in claim 30 wherein one of said plurality of input devices is a step-down button, wherein said step-down button, when activated, causes said microprocessor to decrease said dwell time by a small dwell-time decrement, said small dwell-time decrement causing said final degree of toasting to be decreased by a small degree

34. The control apparatus as described in claim 33 wherein said step-down button, once activated, remains activated for a period of time and then self-deactivates, said period of time being sufficient for one of said bread products to traverse said toasting zone.
